(19) United States
(12) Patent Application Publication
(10) Pub. No.: US 2010/0230129 A1
(43) Pub. Date: Sep. 16, 2010

(54) SYMMETRICAL DATA CABLE FOR COMMUNICATIONS AND DATA TECHNOLOGY

(76) Inventor: Ulrich Hetzer, Berlin (DE)

Correspondence Address: MERCHANT & GOULD PC, P.O. BOX 2903, MINNEAPOLIS, MN, 55402-0903, US

(21) Appl. No.: 12/377,543

(22) PCT Filed: Jul. 18, 2007
(86) PCT No.: PCT/EP2007/006365

§ 371 Date: Feb. 13, 2009

(30) Foreign Application Priority Data
Aug. 16, 2006 (DE) 102006038138.6

(51) Int. Cl. H01B 11/06

(52) U.S. Cl. 174/103

(57) ABSTRACT

The invention relates to a symmetrical data cable (1) for communications and data technology, comprising at least one symmetrical line pair (3) and a cable sheath (2), wherein the line pairs (3) are individually each encapsulated by a ferrite-filled and/or ferrite-coated material.

The invention relates to a symmetrical data cable for communications and data technology.

Symmetrical data cables have at least one symmetrical line pair which is usually twisted. The data cables also have a cable sheath which surrounds the line pairs. In addition, it is known practice, to provide electrical shielding between the cable sheath and the line pairs in order to shield electrical fields. The use of guide elements is known for a defined position of the line pairs, the line pairs being guided in pairs in the channels of said guide elements. On account of the ever increasing transmission frequencies in the case of CAT 6 or 10 Gbit/s Ethernet, the demands imposed on the data cables are correspondingly higher, especially for crosstalk between the cables.

Therefore, the invention is based on the technical problem of providing a symmetrical data cable having improved transmission properties.

The technical problem is solved by the subject matters having the features of claim 1. Further advantageous refinements emerge from the subclaims.

In this respect, the symmetrical data cable for telecommunications and data technology comprises a cable sheath and at least one symmetrical line pair, the line pairs each being individually sheathed with a ferrite-filled and/or ferrite-coated material. This produces common-mode suppression in pairs, which reduces the internal and external crosstalk. In embodiments in which the sheath comprises a ferrite-coated material, the ferrites of adjacent line pairs are preferably prevented from touching one another.

This can be achieved, for example, by applying the coating to the inside or else by providing mechanical separating means between the sheaths. The invention is preferably used for unshielded data cables (UTP).

In one preferred embodiment, the sheath is formed by a ferrite-filled strip which is wound around the line pairs. This results, on the one hand, in the data cable retaining its elasticity and, on the other hand, in the ferrites not touching one another.

In another preferred embodiment, the data cable has a guide element which forms guide channels in which a respective line pair is guided. The guide element preferably has a cruciform cross section, the guide element also preferably being twisted or wound in the longitudinal direction. In principle, however, other profiles are also conceivable for the guide element, for example a plate-shaped design which is then preferably twisted in the longitudinal direction. The data cable preferably has four line pairs.

The invention will be explained in more detail below with reference to one preferred exemplary embodiment. The single FIGURE shows a diagrammatic cross section through two symmetrical data cables.

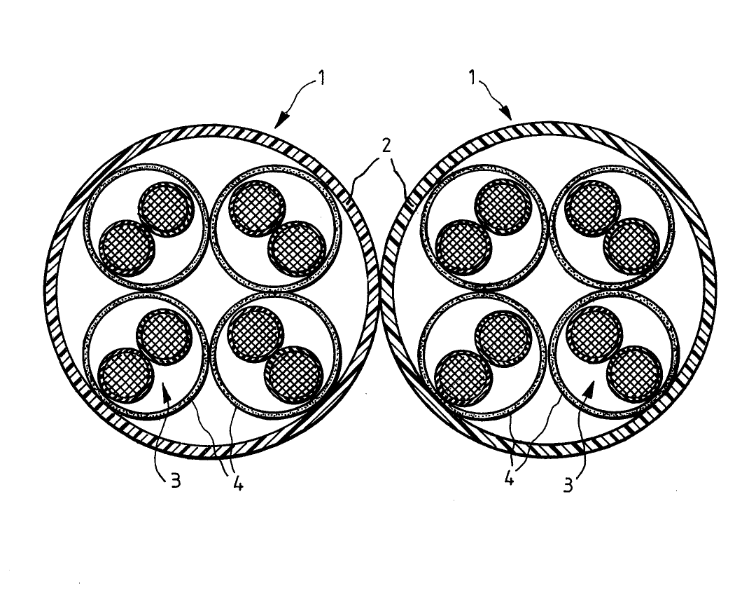

FIG. 1 illustrates two symmetrical data cables 1 in cross section. The data cables 1 each have a cable sheath 2 which surrounds four symmetrical line pairs 3.

The line pairs 3 are in turn sheathed by a ferrite-filled strip 4 which is wound around the line pairs 3. The ferrite-filled strips ensure common-mode suppression in pairs, which reduces the internal and external crosstalk, internal crosstalk denoting the crosstalk between two line pairs 3 in one data cable 1 and external crosstalk denoting the crosstalk between line pairs 3 in different data cables 1. Since the ferrite-filled strips 4 do not give rise to any direct ferrite-ferrite connection, magnetic interference from one line pair 3 to an adjacent line pair 3 via the ferrites is also prevented. In an analogous manner, such interference between the data cables 1 is prevented by the cable sheaths not having any ferrites or not having any ferrites on the outside.

List of reference symbols

| | |
|---|---|
| 1 | Data cable |
| 2 | Cable |
| 3 | Line pairs |
| 4 | Ferrite-filled strip |

1. A symmetrical data cable for communications and data technology, said cable comprising at least one symmetrical line pair and a cable sheath, wherein the line pairs are each individually sheathed with a ferrite-filled and/or ferrite-coated material.

2. The symmetrical data cable as claimed in claim 1, wherein the sheath is formed by a ferrite-filled strip which is wound around the line pairs.

3. The symmetrical data cable as claimed in claim 1, wherein the data cable has a guide element which forms guide channels in which a respective line pair is guided
